(19) United States
(12) Patent Application Publication
(10) Pub. No.: US 2026/0093605 A1
(43) Pub. Date: Apr. 2, 2026

(54) AUTOMATED END-TO-END TESTING USING CONTINUOUS DELIVERY INFRASTRUCTURE AND CENTRALIZED DATA STORAGE

(71) Applicant: eBay Inc., San Jose, CA (US)

(72) Inventor: Valliappan THENAPPAN, San Jose, CA (US)

(21) Appl. No.: 18/901,546

(22) Filed: Sep. 30, 2024

(51) Int. Cl. G06F 11/36

(52) U.S. Cl. CPC G06F 11/3668

(57) ABSTRACT

Some aspects relate to technologies for automated end-to-end testing using a continuous delivery infrastructure and centralized data storage. In accordance with some aspects, a run identifier is generated for a run of a testing pipeline comprising a sequence of test phases that each tests a corresponding code unit. The run identifier is stored in a data store accessible to the testing pipeline. A first test phase is performed to test a first code unit, resulting in the generation of a first test data that is stored in the data store in association with the run identifier. A second test phase is then performed to test a second code unit by accessing the first test data from the data store for use by the second test phase. A second test data is generated by the second test phase and stored in the data store in association with the run identifier.

### BACKGROUND

Software testing is the process of evaluating a software application to ensure it behaves as expected and is free of defects. Generally, there are three main testing approaches - unit testing, integration testing, and end-to-end testing. Unit tests focus on testing individual components or functions in isolation, ensuring that each small piece of code (i.e., code unit) works correctly on its own. Integration tests assess how different code units work together, verifying that interactions between components function as intended. End-to-end tests evaluate the entire system by simulating real user scenarios, checking that the application operates seamlessly from start to finish across multiple components and layers.

### SUMMARY

Some aspects of the present technology relate to, among other things, a testing system that provides for automated end-to-end testing using a continuous delivery infrastructure and centralized data storage. The testing system leverages a continuous delivery platform that orchestrates and automates the execution of various test phases within the testing process. The testing system also uses a centralized data store for propagation of test data between different test phases of a testing pipeline, allowing seamless data exchange throughout the entire automated testing workflow. This technology also provides support for multiple programming languages, including situations in which a testing pipeline comprises test phases that are testing code written in different programming languages.

In accordance with some aspects of the technology described herein, any number of testing pipelines are defined. Each testing pipeline specifies a sequence of test phases and corresponding code units to be tested by the test phases. Additionally, each testing pipeline can be run any number of times to generate testing information regarding the performance of each test run. During a run of a testing pipeline, the testing system generates a run identifier and persists the run identifier in a centralized data store, which could be a key-value store with the run identifier stored as a key. The testing system automatically performs each test phase in the sequence specified by the testing pipeline. At each test phase, any test data generated by that test phase is persisted to the centralized data store with the run identifier. Additionally, at each test phase, any test data generated by previous test phase(s) can be retrieved from the centralized data store using the run identifier, and the retrieved test data is used to perform the test phase. Testing information regarding the status of each test phase of the run (e.g., success, warning, failure, error, canceled) and, in some cases, details regarding the status (e.g., why a test phase resulted in a failure) are persisted. Testing information across one or more runs of a testing pipeline can be used to generate user interfaces that analyze the run history of the testing pipeline for code debugging and other software development and deployment activities.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram showing an example set API for writing test data to a key-value store in accordance with some implementations of the present disclosure;

FIG. 3 is a diagram showing an example get API for accessing test data from a key-value store in accordance with some implementations of the present disclosure;

FIG. 4 is a diagram showing an example of data stored in a key-value store for a run of a testing pipeline in accordance with some implementations of the present disclosure;

FIG. 5 is a block diagram showing example testing pipeline for automated end-to-end testing using a continuous delivery infrastructure and key-value storage in accordance with some implementations of the present disclosure;

FIG. 6 is an example user interface presenting different testing pipelines in accordance with some implementations of the present disclosure;

FIG. 7 is an example user interface presenting different runs for a selected testing pipeline in accordance with some implementations of the present disclosure;

FIG. 8 is an example user interface presenting testing results for a selected run of a testing pipeline in accordance with some implementations of the present disclosure;

FIG. 9 is an example user interface presenting testing results for a selection of runs of a testing pipeline in accordance with some implementations of the present disclosure;

FIG. 10 is a flow diagram showing a method for automated end-to-end testing using a continuous delivery infrastructure and centralized data storage in accordance with some implementations of the present disclosure; and

FIG. 11 is a block diagram of an exemplary computing environment suitable for use in implementations of the present disclosure.

### DETAILED DESCRIPTION

### Overview

Relative to unit testing and integration testing, end-to-end testing provides a more robust and comprehensive view of system functionality. However, there are a number of shortcomings of current end-to-end testing approaches, which often leads software developers/testers to rely more heavily on unit testing and integration testing. In particular, current approaches for end-to-end testing are typically reliant on partially automated testing, leading to several challenges. Inefficiency and Time Consumption: Since partially automated testing requires some human involvement, it is a slow and laborious process, hindering the velocity of product development and deployment. Error Proneness: Current approaches are susceptible to human error, potentially allowing critical bugs to go undetected until later stages, impacting campaign performance and user experience. Limited Test Coverage: The laborious process of developing end-to-end tests often results in not covering all possible scenarios or user interactions, leading to potential issues arising in production environments. Inconsistent Testing Practices: The testing approaches used can be subjective and vary depending on the tester, potentially leading to inconsistencies in the testing process. Limited code integration: Different software development teams are typically responsible for developing and maintaining different components of a software application and often write code using different languages, creating a challenge in providing automated testing across the various components. Among other things, these challenges associated with end-to-end testing can result in delayed product launches due to slow testing cycles and bugs escaping detection until later stages, causing disruption.

Aspects of the technology described herein improve the functioning of the computer itself in light of these shortcomings in current software testing approaches by a solution that provides for automated end-to-end testing using a combination of a continuous delivery platform with a centralized data store for sharing test data between test phases. The testing system described herein leverages a continuous delivery platform to orchestrate and automate the execution of various test phases within the testing process. The continuous delivery platform provides functionalities such as scheduling tests, managing test dependencies, and storing test run history for analysis. The centralized data store addresses the challenge of data propagation between different test phases within a testing pipeline. The centralized data store provides for storage and retrieval of test data (e.g., user identifiers, item identifiers, etc.) generated during each test phase, allowing seamless data exchange throughout the entire automated testing workflow.

In accordance with some aspects of the technology described herein, a testing pipeline is defined to provide for end-to-end testing of a software application. The testing pipeline sets forth a sequence of test phases for testing various code units of the software application. Any number of different testing pipelines can be defined to test various scenarios, and each testing pipeline can be run any number of times.

During a run of a testing pipeline, the testing system generates a run identifier that uniquely identifiers the run and stores the run identifier in a centralized data store. In some aspects, the centralized data store is a key-value store in which the run identifier is stored as a key. The testing system retrieves the code units to be tested from a code repository and performs each test phase in the sequence specified by the testing pipeline. Any test data generated during a test phase is persisted in the centralized data store in association with the run identifier. In configurations using a key-value store, the test data is stored as values (e.g., attribute-value pairs) in association with the run identifier stored as the key. Additionally, at each test phase, test data generated by previous test phases can be retrieved from the centralized data store using the run identifier to look up and access the data, and the testing system employs the retrieved test data to perform the test phase.

The testing system also persists testing information regarding the performance of each run of a testing pipeline to provide run histories for analysis. The testing information for a run of a testing pipeline can include a performance status for each test phase, such as whether the test phase was a success, generated a warning, resulted in a failure, generated an error, or was canceled. In some aspects, the testing information also includes details regarding the status of each test phase, such as why a test phase resulted in failure. The testing system employs the testing information to generate user interfaces that facilitate analysis of the run histories for each testing pipeline.

Aspects of the technology described herein provide a number of improvements over existing software testing approaches. For instance, the technology described herein provides a fully automated and scalable end-to-end testing solution that offers significant advantages in terms of efficiency, test coverage, and data management relative to conventional testing approaches. The automated approach reduces manual effort, freeing up valuable time for development teams to focus on other tasks. This technology also provides support for multiple programming languages, including situations in which a testing pipeline comprises test phases that are testing code written in different programming languages. Additionally, the approach allows for more comprehensive test coverage (i.e., testing more end-to-end scenarios). The centralized data management also improves data accessibility and consistency across code units and development teams. The use of a key-value store in some aspects provides a common solution that allows for code in different languages to read/write (e.g., via APIs) test data to/from the key-value store. Unlike relational databases, the key-value store uses keys to directly access the values needed at each test phase without complex querying or relationships. Relative to existing test solutions, the technology described reduces the delay in product launches due to slow testing cycles, reduces bugs escaping detection, and provides for earlier defect detection and resolution.

### Example System for Automated End-to-End Testing

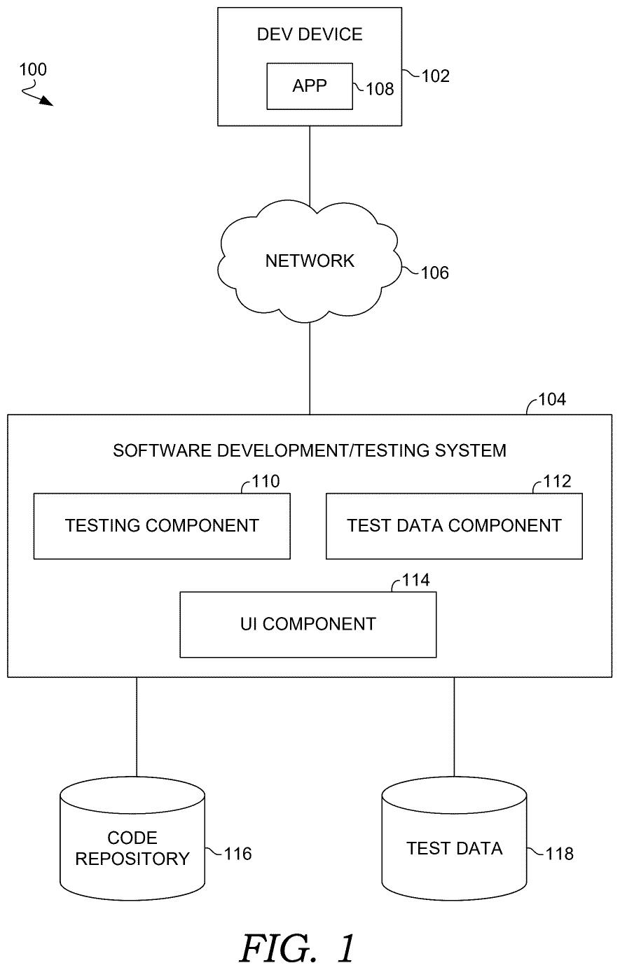

With reference now to the drawings, FIG. 1 is a block diagram illustrating an exemplary system 100 for automated end-to-end testing using a continuous delivery infrastructure and centralized data storage in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

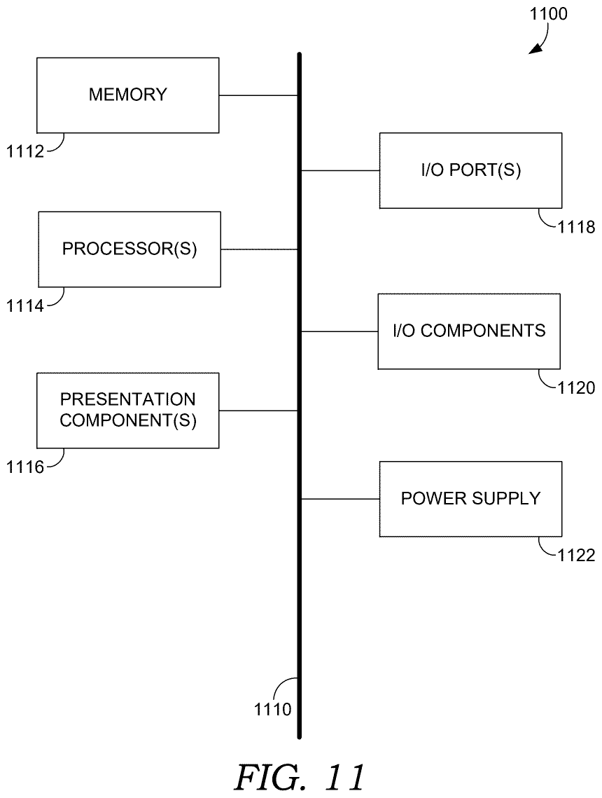

The system 100 is an example of a suitable architecture for implementing certain aspects of the present disclosure. Among other components not shown, the system 100 includes a developer device 102 and a software development/testing system 104. Each of the developer device 102 and the software development/testing system 104 shown in FIG. 1 can comprise one or more computer devices, such as the computing device 1100 of FIG. 11, discussed below. As shown in FIG. 1, the developer device 102 and the software development/testing system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of developer devices and servers can be employed within the system 100 within the scope of the present technology. Each can comprise a single device or multiple devices cooperating in a distributed environment. For instance, the software development/testing system 104 could be provided by multiple server devices collectively providing the functionality of the software development/testing system 104 as described herein. Additionally, other components not shown can also be included within the network environment.

The developer device 102 can be a client device on the client-side of operating environment 100, while the software development/testing system 104 can be on the server-side of operating environment 100. The software development/testing system 104 can comprise server-side software designed to work in conjunction with client-side software on the developer device 102 so as to implement any combination of the features and functionalities discussed in the present disclosure. For instance, the developer device 102 can include an application 108 for interacting with the software development/testing system 104. The application 108 can be, for instance, a web browser or a dedicated application for providing functions, such as those described herein. This division of operating environment 100 is provided to illustrate one example of a suitable environment, and there is no requirement for each implementation that any combination of the developer device 102 and the software development/testing system 104 remain as separate entities. While the operating environment 100 illustrates a configuration in a networked environment with a separate developer device and software development/testing system, it should be understood that other configurations can be employed in which components are combined. For instance, in some configurations, a developer device can provide some or all capabilities described in conjunction with the software development/testing system.

The developer device 102 can comprise any type of computing device capable of use by a user. For example, in one aspect, the developer device can be the type of computing device 1100 described in relation to FIG. 11 herein. By way of example and not limitation, the developer device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user, such as a software developer/tester, can be associated with the developer device 102 and can interact with the software development/testing system 104 via the developer device 102.

The software development/testing system 104 provides a platform for developing, testing, and deploying software. As shown in FIG. 1, the software development/testing system 104 includes a testing component 110, test data component 112, and a user interface component 114. The components of the software development/testing system 104 can be in addition to other components that provide further additional functions beyond the features described herein. The software development/testing system 104 can be implemented using one or more server devices, one or more platforms with corresponding application programming interfaces, cloud infrastructure, and the like. While the software development/testing system 104 is shown separate from the developer device 102 in the configuration of FIG. 1, it should be understood that in other configurations, some or all of the functions of the software development/testing system 104 can be provided on the developer device 102.

In one aspect, the functions performed by components of the software development/testing system 104 are associated with one or more applications, services, or routines. In particular, such applications, services, or routines can operate on one or more developer devices, servers, can be distributed across one or more developer devices and servers, or be implemented in the cloud. Moreover, in some aspects, these components of the software development/testing system 104 can be distributed across a network, including one or more servers and client devices, in the cloud, and/or can reside on a developer device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

In some aspects, the software development/testing system 104 provides a continuous delivery platform for building, testing, and deploying software. The continuous delivery platform (sometimes referred to as a continuous integration and continuous delivery platform) enables different development teams to make code changes to code units, which are maintained in a code repository 116, and integrates various code units from the development teams into software applications for deployment. By way of example only and not limitation, an example of software that could be developed, tested, and deployed using a continuous delivery platform is a web-based e-commerce application. This type of software involves multiple components (each provided by one or more code units) like a user interface, a backend API, a payment processing system, and a database. Using a continuous delivery platform, developers can implement new features, such as adding new product categories or updating the shopping cart, while testing ensures that existing functionality remains intact. In some implementations, the platform can deploy the updates to a staging environment for further testing and eventually to production, providing a seamless experience for developers.

The testing component 110 of the software development/testing system 104 provides for end-to-end testing that enables passing test data between test phases. While aspects of the technology described herein are directed to end-to-end testing, it should be noted that the testing component 110 could also provide for other forms of testing, such as unit testing and integration testing.

In accordance with some aspects, the testing component 110 allows a developer using a developer device, such as the developer device 102, to define a testing pipeline by specifying a sequence of test phases and code units associated with the test phases. Accordingly, the testing pipeline comprises an end-to-end test for a software application that is provided by integrating multiple separate code units. The testing component 110 allows for any number of different testing pipelines to be defined.

Each code unit specified by a testing pipeline is stored in the code repository 116. The code repository 116 can comprise a centralized storage location where developers keep, manage, and track their code and related files. In some aspects, the code repository 116 enables version control, allowing multiple developers to collaborate on a project by tracking changes, managing different versions of the code, and merging updates from different contributors. Examples of version control systems for code repositories include Git (used with platforms like GitHub, GitLab, and Bitbucket), Subversion (SVN), and Mercurial. The code repository 116 can help maintain a complete history of code changes, making it easier to roll back to previous versions and ensure collaboration across development teams.

After a testing pipeline has been defined, the testing component 110 performs runs of the testing pipeline. Each run of the testing pipeline comprises an end-to-end test of the software application that involves the execution of the sequence of test phases specified by the testing pipeline that verify the quality and functionality of code changes across different code units. Each run of a testing pipeline can be manually initiated by a developer or can be automatically triggered by events, such as a code commit. During a test run, the testing component 110 generates a run identifier that uniquely identifies the run. The testing component 110 accesses the code unit associated with each test phase from the code repository 116 and performs each test phase in the sequence specified by the testing pipeline. Additionally, the testing component 110 persists, in data storage, the status of each test phase for each run. For instance, the status of a test phase of a given run of a testing pipeline can indicate whether performance of the test phase resulted in a success, warning, failure, error, or was canceled. The testing component 110 can also persist, in data storage, information regarding the status of each test phase. For instance, if a test phase resulted in a failure, information describing the failure determined from performance of the test phase can be persisted with the status of that test phase. The status and any associated information for each test phase of a run of a testing pipeline are stored with the run identifier. This provides a collection of information regarding each test run of a testing pipeline.

To enable automated end-to-end testing for a run of a testing pipeline, the software development/testing system 104 includes a test data component 112 that facilitates sharing of test data between test phases. In particular, when a test phase is performed by the testing component 110, the test phase can produce test data needed by one or more subsequent test phases in the testing pipeline. Accordingly, the test data component 112 facilitates storing test data generated by test phases in a test data store 118. The test data component 112 also facilitates retrieval of test data from the test data store 118 as needed by test phases. When a run of a testing pipeline is initiated, the run identifier that is generated to uniquely identify the run is stored in the test data store 118. When test data are generated during the run, the test data are stored in the test data store 118 in association with the run identifier. Each test data can comprise, for instance, an attribute-value pair that identifies an attribute using an attribute name and specifies a value for the attribute.

The test data store 118 comprises a centralized data storage for sharing test data between test phases, regardless of the coding language used by the code units being tested. In accordance with some aspects of the technology described herein, the test data store 118 comprises a key-value store. In such configurations, run identifiers of runs are stored as keys in the key-value store. Additionally, test data generated by test phases of a test run are stored as values in association with the run identifier. Using a key-value store facilitates quick and efficient sharing of test data among the test phases. During a run, the run identifier is used as a key to facilitate writing test data to the test data store 118 and reading test data from the test data store 118 during each test phase.

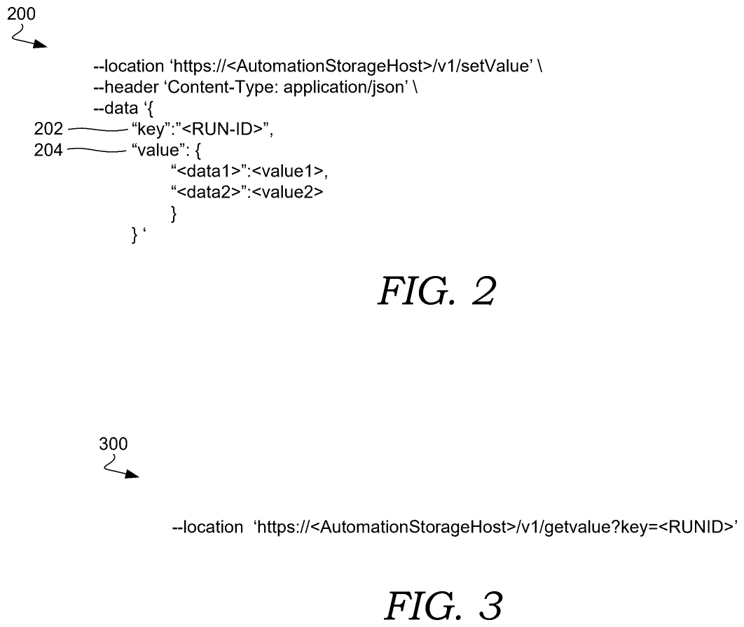

The test data component 112 can employ APIs to read/write test data in the test data store 118. For instance, in some configurations, the test data component 112 employs a set API to store test data for a test run of a testing pipeline in the test data store 118. In particular, when a test phase generates test data, the test data component 112 calls the set API to store the test data from the test phase in the test data store 118. By way of example to illustrate, FIG. 2 is a diagram showing a set API 200 for writing test data to a key-value store. As shown in FIG. 2, the set API 200 specifies the run identifier as the key 202 and one or more values 204 as attribute-value pairs. This set API 200 causes the one or more values 204 to be stored as values in the key-value store in association with the run identifier for the run, which is stored as a key in the key-value store.

The test data component 112 can also employ a get API to access test data for a test run of a testing pipeline from the test data store 118. In particular, when a test phase is being performed, the test data component 112 calls the get API to retrieve test data generated by one or more previous test phases and stored in the test data store 118. By way of example to illustrate, FIG. 3 is a diagram showing a get API 300 for accessing test data from a key-value store. As shown in FIG. 3, the get API 300 specifies the run identifier as the key in order to retrieve test data stored as values with the run identifier in the key-value store.

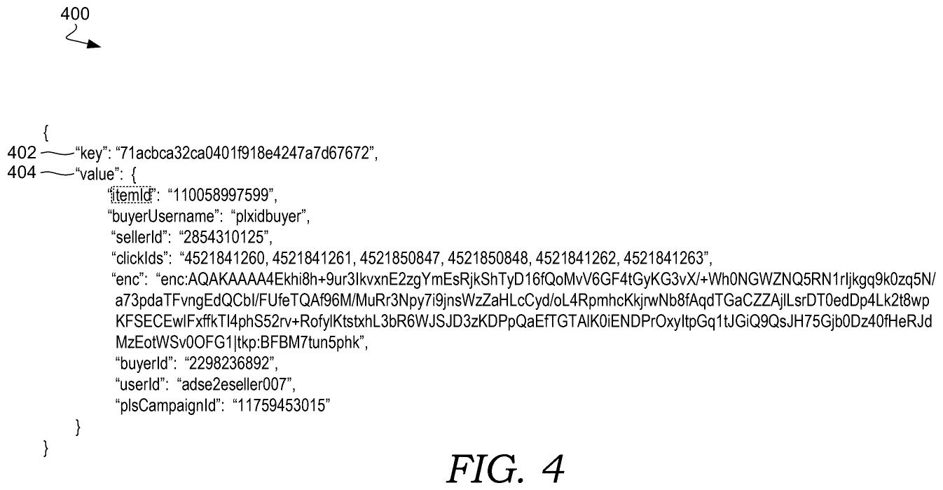

FIG. 4 is a diagram showing an example of data 400 stored in a key-value store for a run of a testing pipeline. As shown in FIG. 4, the data 400 includes a key 402, which is the run identifier for the run (i.e., “71acbca32ca0401f918e4247a7d67672”). The data 400 also includes values 404 stored in association with the key 402. Each of the values 404 is test data comprising an attribute-value pair that specifies an attribute name and a value for the attribute (e.g., “itemId: 110058997599”; etc.). The test data can be added to the key-value store as generated by each test phase and then retrieved by subsequent test phases. For instance, a first test phase could generate a test data comprising an itemId, which is added to the data 400. A second test phase could retrieve the itemId to perform the second test phase and generate test data comprising a buyerUsername and a sellerId, which are added to the data 400. The run continues with each subsequent test phase accessing test data from the data 400 as needed to perform each test phase and test data generated by each test phase are added to the data 400 to ultimately provide the extent of data 400 shown in FIG. 4.

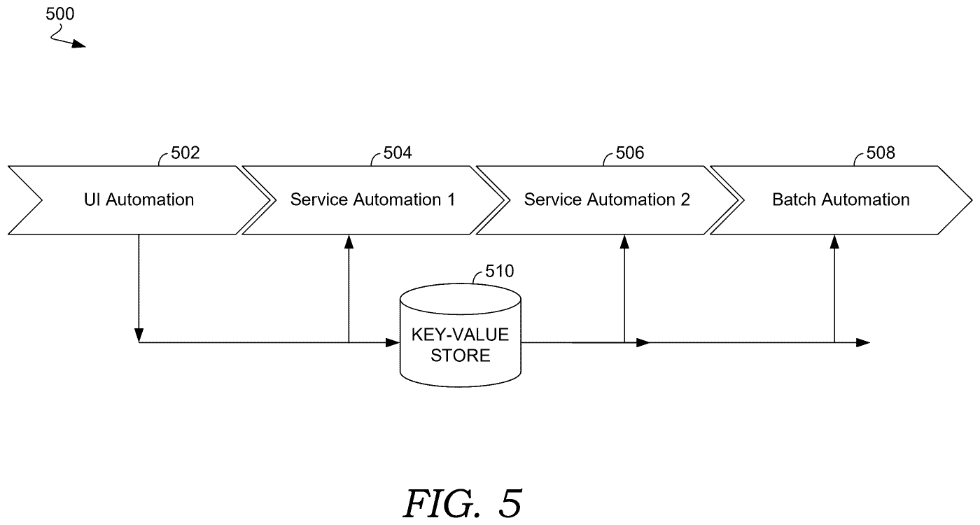

FIG. 5 is a block diagram showing an example testing pipeline 500 for automated end-to-end testing using a continuous delivery infrastructure and key-value storage. The testing pipeline 500 in the current example includes four test phases 502, 504, 506, 508. However, it should be understood that a testing pipeline can include any number of test phases. At each test phase 502, 504, 506, 508, testing is performed on a code unit. During each test phase, test data generated by the test phase are stored in a key-value store 510. Additionally, during each test phase, at least a portion of test data from previous test phase(s) can be retrieved from the key-value store 510 and used to perform the test phase. For instance, during the first test phase 502, test data comprising one or more attribute-value pairs could be generated and stored in the key-value store 510 in association with a run identifier for the run stored as a key. During the second test phase 504, test data from the first test phase 502 can be retrieved from the key-value store 510 (using the run identifier for the run as the key) in order to perform the second test phase 504. Test data generated during the second test phase 504 is also stored in the key-value store 510 in association with the run identifier for the run. The third test phase 506, followed by the fourth test phase 508, can then each be performed by accessing test data from previous test phase(s) stored in the key-value store 510 and also writing any test data generated by each test phase to the key-value store 510 in association with the run identifier for the run. Additionally, the status of each test phase, which reflects the result of the testing performed by the test phase (e.g., success, warning, failure, error, canceled), is also persisted in association with the run identifier to facilitate analysis of the run. In some aspects, details regarding the status of each test phase (e.g., why a test phase was a failure or a description of an error) are also persisted with the status of each test phase.

Any number of runs of a testing pipeline, such as the testing pipeline 500 in FIG. 5, can be performed. For each run, a different run identifier is generated and stored in the key-value store 510, and test data for each run is stored in association with its corresponding run identifier. This allows each run to generate and use different test data that can be unique to each run. Additionally, testing information is persisted for test phases of each run. This allows for analysis of the test runs of the testing pipeline.

With reference again to FIG. 1, the software development/testing system 104 further includes a user interface component 114 that provides one or more user interfaces for interacting with the software development/testing system 104. The user interface component 114 provides one or more user interfaces to a developer device, such as the developer device 102. In some instances, the user interfaces can be presented on the developer device 102 via the application 108, which can be a web browser or a dedicated application for interacting with the software development/testing system 104. Among other things, the user interface component 114 can provide user interfaces for interacting with the software development/testing system 104 to define and edit testing pipelines, perform runs of testing pipelines, and access/analyze testing information resulting from the runs.

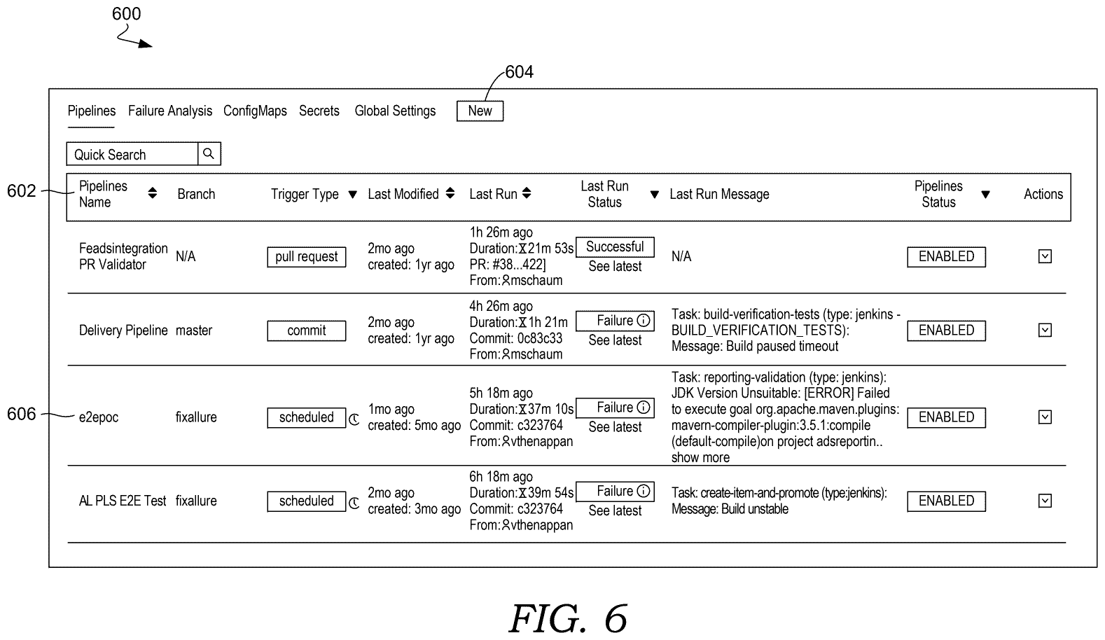

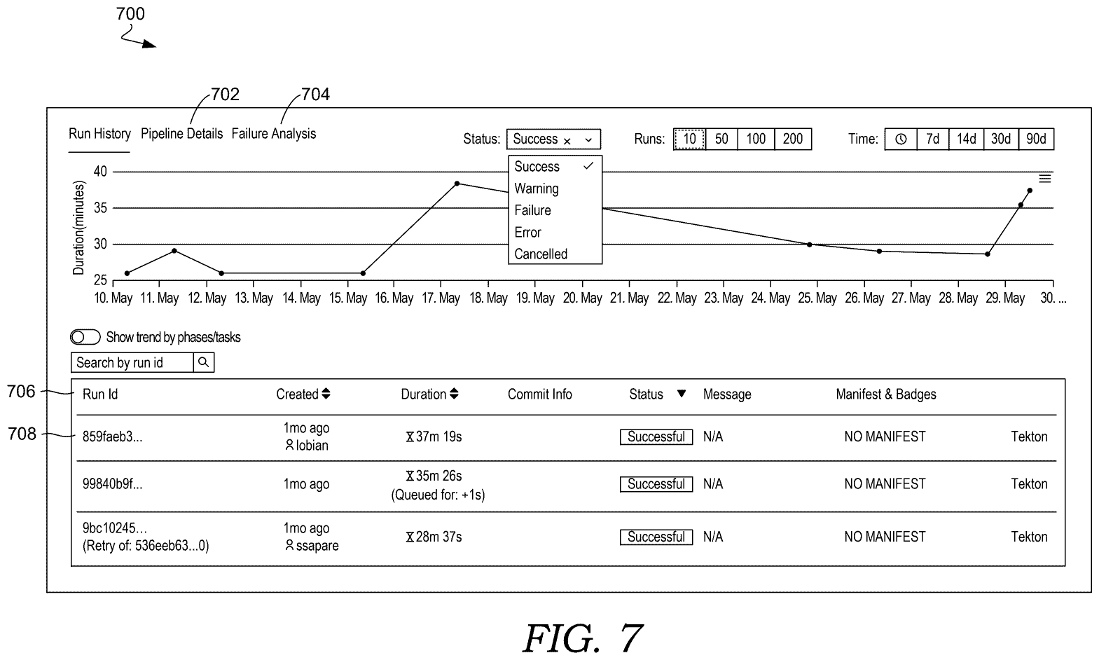

By way of illustration, FIGS. 6-9 provide example user interfaces that can be provided by the user interface component 114. With initial reference to FIG. 6, an example user interface 600 is provided that presents a dashboard listing various testing pipelines that have been generated and run. The user interface 600 identifies a pipeline name 602 for each testing pipeline. The user interface 600 also provides various information for each pipeline, including a type of trigger for performing runs (e.g., code commit, scheduled, etc.), when the pipeline was last modified, when the pipeline was last run, the status of the last run (e.g., success, failure, etc.), message regarding the last run (e.g., indication of where failures/errors occurred in the pipeline), and a pipeline status (e.g., enabled or disabled). The user interface 600 further includes a user-selectable button 604 that enables the developer to generate a new testing pipeline.

The developer can select a particular testing pipeline to obtain more detailed information regarding the selected testing pipeline. For instance, if the developer were to select the “e2epoc” testing pipeline 606 in the user interface 600 of FIG. 6, a user interface such as that shown in FIG. 7 is provided. In particular, FIG. 7 provides an example user interface 700 presenting a run history for the selected testing pipeline. The developer can also access a user interface providing pipeline details by selecting the user interface element 702 (e.g., to view test phases and code units for the testing pipeline and to potentially modify the testing pipeline as needed). The developer can further access a user interface providing failure analysis information for the testing pipeline by selecting the user interface element 704.

As shown in FIG. 7, the user interface 700 identifies a run identifier 706 for each run of the testing pipeline. The user interface 700 also provides various information for each run, including when the run was performed, the duration of the run, and a status of the run (e.g., success, failure, etc.). The developer can filter the runs by status (e.g., success, warning, failure, error, canceled) in order to focus on runs with a certain status.

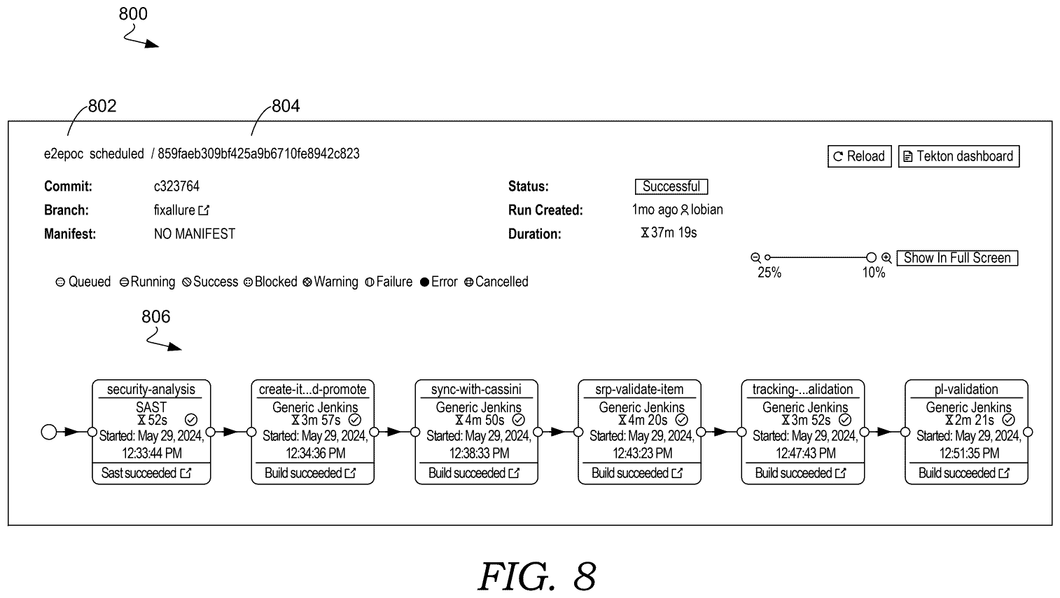

The developer can select a particular run to obtain more detailed information regarding the selected run. For instance, if the developer were to select the “859faeb3. . .” run 708 from the user interface 700 of FIG. 7, a user interface such as that shown in FIG. 8 is provided. In particular, FIG. 8 provides an example user interface 800 that provides details for the selected run. The user interface identifies the name 802 of the selected testing pipeline and the run identifier 804 for the selected run. Details regarding the run include the status, when the run occurred, and the duration of the run. The user interface 800 also provides a test run display area 806 that presents each test phase as a block. Each test phase block in the test run display area 806 provides information regarding the test phase, such as, for instance, an indication of the code unit tested, the type of test performed, the run time of the test phase, a time stamp of when the test phase was performed, and the status of the test phase (e.g., success, warning, failure, error, canceled).

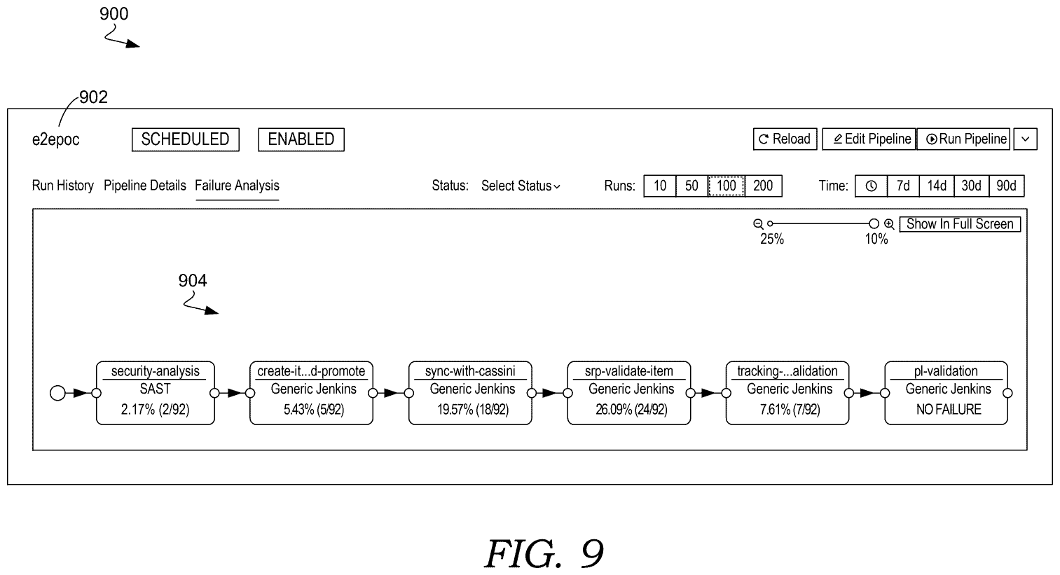

If the developer selects the failure analysis user interface element 704 in the user interface 700 of FIG. 7, a user interface such as that shown in FIG. 9 is provided. In particular, FIG. 9 provides an example user interface 900 that presents aggregate information for multiple runs of the selected testing pipeline. As shown in FIG. 9, the user interface 900 identifies the name 902 of the testing pipeline. The user interface 900 also provides a test run display area 904 that presents each test phase of the testing pipeline as a block. Each test phase block in the test run display area 904 provides information for a collection of runs of the testing pipeline, such as, for instance, an indication of the code unit tested, the type of test performed, and overall status information for the collection of runs. For instance, a test phase block can provide a percentage of runs that resulted in a failure of that given test phase or an indication of no failures in the case of a test phase that was successful in all runs of the testing pipeline.

### Example Method for Automated End-to-end Testing

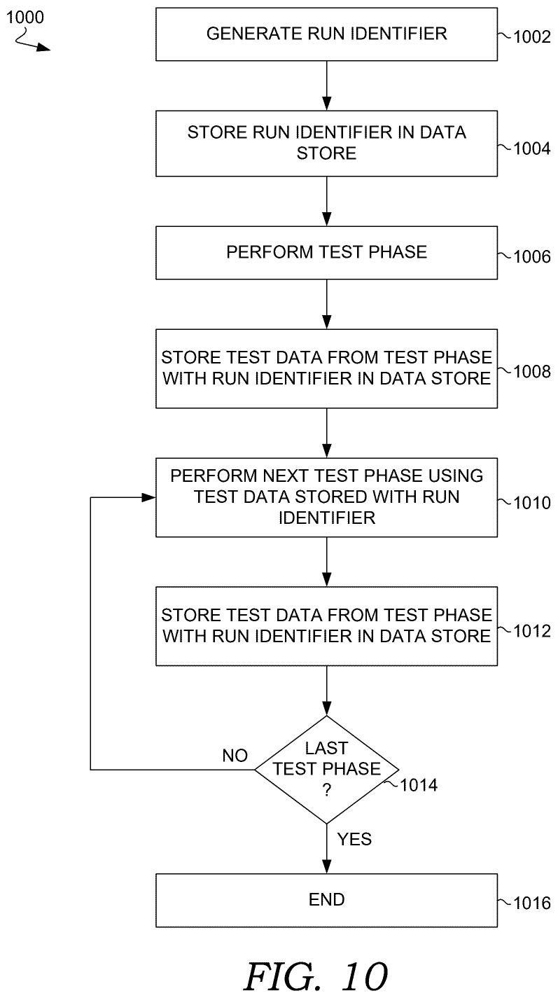

With reference now to FIG. 10, a flow diagram is provided that illustrates a method 1000 for automated end-to-end testing using a continuous delivery infrastructure and a centralized data storage. The method 1000 can be performed, for instance, by the software development/testing system 104 of FIG. 1. Each block of the method 1000 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

The method 1000 illustrates a process for a single run of a testing pipeline, which can be performed for any number of runs. The testing pipeline generally comprises a series of test phases, where each test phase tests a corresponding code unit. As shown at block 1002, a run identifier is generated for the run. The run identifier uniquely identifies the run of the testing pipeline. As shown at block 1004, the run identifier is stored in a centralized data store, which could be a key-value store (for instance, the test data store 118 of FIG. 1). The run identifier can be stored as a key of a key-value store.

A first test phase of the testing pipeline is performed, as shown at block 1006. Any test data generated by the first test phase are stored as values with the run identifier in the centralized data store, as shown at block 1008. For instance, the process can employ a set API that includes the run identifier and an attribute-value pair for each test data generated from the first test phase in order to store the attribute-value pair(s) with the run identifier in the data store.

As shown at block 1010, a next test phase in the testing pipeline is performed. The next test phase is performed using test data stored in the centralized data store. For instance the process can employ a get API that includes the run identifier. The API causes a lookup to be performed on a key-value store using the run identifier as the key and returns test data (e.g., one or more attribute-value pairs) that are used during the test phase. Any test data generated by the current test phase are stored as values with the run identifier in the centralized data store, as shown at block 1012. For instance, the process can employ a set API that includes the run identifier and an attribute-value pair for each test data generated from the current test phase.

A determination is made at block 1014 regarding whether the last test phase of the testing pipeline has been performed. If not, the process returns to block 1010 to perform the next test phase in the testing pipeline. At each test phase, test data from previous test phases and stored in the centralized data store can be retrieved and used during the test phase. Additionally, at each test phase, any test data generated by that test phase is stored in the centralized data store for use by subsequent test phases. However, some test phases of a testing pipeline may not need test data from previous phases and/or may not generate test data to be added to the data store, such that the test data reading and/or writing steps are not performed for those test phases. When all test phases have been performed, the process ends as shown at block 1016.

Although not shown in FIG. 10, testing information regarding the result of each test phase of a run of a testing pipeline can also be persisted in data storage. For instance, the status of each test phase can be persisted in association with the run identifier as each test phase is performed. The status of a given test phase reflects the result of performing that test phase (e.g., success, warning, failure, error, canceled). In some aspects, details regarding the status of each test phase can also be persisted. For instance, for a test phase that resulted in a failure, details regarding the failure can be persisted. The persisted information for each test phase of the test run allows for generating user interfaces (such as those shown in FIGS. 6-9) to facilitate analysis of test runs of the testing pipeline by a developer.

### Exemplary Operating Environment

Having described implementations of the present disclosure, an exemplary operating environment in which embodiments of the present technology can be implemented is described below in order to provide a general context for various aspects of the present disclosure. Referring initially to FIG. 11 in particular, an exemplary operating environment for implementing embodiments of the present technology is shown and designated generally as computing device 1100. Computing device 1100 is but one example of a suitable computing environment and is not intended to suggest any limitation as to the scope of use or functionality of the technology. Neither should the computing device 1100 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 11, computing device 1100 includes bus 1110 that directly or indirectly couples the following devices: memory 1112, one or more processors 1114, one or more presentation components 1116, input/output (I/O) ports 1118, input/output components 1120, and illustrative power supply 1122. Bus 1110 represents what can be one or more busses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 11 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1100. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1112 includes computer storage media in the form of volatile and/or nonvolatile memory. The memory can be removable, non-removable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which can be built in. Illustrative components include a microphone, joystick, game pad, satellite dish, scanner, printer, wireless device, etc. The I/O components 1120 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1100. The computing device 1100 can be equipped with depth cameras, such as, stereoscopic camera systems, infrared camera systems, RGB camera systems, and combinations of these for gesture detection and recognition. Additionally, the computing device 1100 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving. ” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” also includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
generating a run identifier for a first run of a testing pipeline comprising a sequence of a plurality of test phases, each test phase testing a corresponding code unit;
storing the run identifier in a data store accessible to the testing pipeline;
performing a first test phase of the first run to test a first code unit;
during the first test phase of the first run, generating a first test data;
storing, in the data store in association with the run identifier, the first test data;
performing a second test phase of the first run to test a second code unit;
during the second test phase of the first run, accessing the first test data from the data store for use by the second test phase of the first run and generating a second test data; and
storing, in the data store in association with the run identifier, the second test data.

2. The one or more computer storage media of claim 1, wherein the first test data comprises a first value for a first attribute and is stored as a first attribute-value pair based on the first value and the first attribute; and wherein the second test data comprises a second value for a second attribute and is stored as a second attribute-value pair based on the second value and the second attribute.

3. The one or more computer storage media of claim 1, wherein the operations further comprise:
during a third test phase of the first run, accessing the first test data and/or
the second test data from the data store for use by the third test phase of the first run and generating a third test data; and
storing, in the data store in association with the run identifier, the third test data.

4. The one or more computer storage media of claim 1, wherein the operations further comprise:
generating a second run identifier for a second run of the testing pipeline;
storing the second run identifier in the data store;
during a first test phase of the second run, generating a third test data;
storing, in the data store in association with the second run identifier, the third test data;
during a second test phase of the second run, accessing the third test data from the data store for use by the second test phase of the second run and generating a fourth test data; and
storing, in the data store in association with the second run identifier, the fourth test data.

5. The one or more computer storage media of claim 4, wherein the operations further comprise:
during a third test phase of the second run, accessing the third test data and/or the fourth test data from the data store for use by the third test phase of the second run and generating a fifth test data; and
storing, in the data store in association with the second run identifier, the first test data.

6. The one or more computer storage media of claim 1, wherein the data store comprises a key-value store that stores the run identifier as a key and the first test data and the second test data as values in association with the key.

7. The one or more computer-storage media of claim 1, wherein the operations further comprise:
storing first testing information for the first test phase of the first run;
storing second testing information for the second test phase of the first run; and
generating a user interface presenting the first testing information and the second testing information.

8. The one or more computer-storage media of claim 7, wherein the first testing information comprises an indication of a status of the first test phase of the first run, and wherein the second testing information comprises an indication of a status of the second test phase of the first run.

9. The one or more computer storage media of claim 1, wherein the first test phase of the first run tests a first code unit and the second test phase of the first run tests a second code unit, and wherein the first code unit and the second code unit are written in different coding languages.

10. A computer-implemented method comprising:
generating a run identifier for a first run of a testing pipeline comprising a plurality of test phases, each test phase testing a corresponding code unit;
storing the run identifier as a key in a key-value store accessible to the testing pipeline;
performing a first test phase of the first run to test a first code unit;
during the first test phase of the first run, generating a first value for a first attribute;
storing, in the key-value store in association with the run identifier, a first attribute-value pair based on the first value and the first attribute;
performing a second test phase of the first run to test a second code unit;
during the second test phase of the first run, accessing the first value from the key-value store for use by the second test phase of the first run and generating a second value for a second attribute; and
storing, in the key-value store in association with the run identifier, a second attribute-value pair based on the second value and the second attribute.

11. The computer-implemented method of claim 10, wherein the operations further comprise:
during a third test phase of the first run, accessing the first value and/or the second value from the key-value store for use by the third test phase of the first run and generating a third value for a third attribute; and
storing, in the key-value store in association with the run identifier, a third attribute-value pair based on the third value and the third attribute.

12. The computer-implemented method of claim 10, wherein the operations further comprise:
generating a second run identifier for a second run of the testing pipeline;
storing the second run identifier as a second key in the key-value store;
during a first test phase of the second run, generating a third value for the first attribute;
storing, in the key-value store in association with the second run identifier, a third attribute-value pair based on the third value and the first attribute;
during a second test phase of the second run, accessing the third value from the key-value store for use by the second test phase of the second run and generating a fourth value for the second attribute; and
storing, in the key-value store in association with the second run identifier, a fourth attribute-value pair based on the fourth value and the second attribute.

13. The computer-implemented method of claim 12, wherein the operations further comprise:
during a third test phase of the second run, accessing the third value and/or the fourth value from the key-value store for use by the third test phase of the second run and generating a fifth value for the third attribute; and
storing, in the key-value store in association with the second run identifier, a fifth attribute-value pair based on the fifth value and the third attribute.

14. The computer-implemented method of claim 10, wherein the operations further comprise:
storing first testing information for the first test phase of the first run;
storing second testing information for the second test phase of the first run; and
generating a user interface presenting the first testing information and the second testing information.

15. The computer-implemented method of claim 14, wherein the first testing information comprises an indication of a status of the first test phase of the first run, and wherein the second testing information comprises an indication of a status of the second test phase of the first run.

16. The computer-implemented method of claim 10, wherein the first test phase of the first run tests a first code unit and the second test phase of the second run tests a second code unit, wherein the first code unit and the second code unit are written in different coding languages.

17. A computer system comprising:
a processor; and
a computer storage medium storing computer-useable instructions that, when used by the processor, causes the computer system to perform operations comprising:
generating a testing pipeline specifying a sequence of a plurality of test phases for an automated end-to-end test of a software application, each test phase testing a corresponding code unit of the software application that is stored in a code repository of a continuous delivery platform;
generating a run identifier for a first run of the testing pipeline;
storing the run identifier as a key in a key-value store accessible to the continuous delivery platform; and
executing the first run of the testing pipeline by the continuous delivery platform performing each of the plurality of test phases in the sequence specified by the testing pipeline, wherein performance of a first test phase of the first run by the continuous delivery platform generates a first test data that is stored as a value in the key-value store in association with the run identifier, and wherein performance of a subsequent test phase of the first run by the continuous delivery platform uses the run identifier as the key to retrieve the first test data from the key-value store for use by the subsequent test phase of the first run.

18. The computer system of claim 17, wherein the first test data comprises an attribute-value pair for a first attribute.

19. The computer system of claim 17, wherein performance of the subsequent test phases of the first run by the continuous delivery platform generates a second test data that is stored as a second value in the key-value stored in association with the run identifier, and wherein performance of a second subsequent test phase of the first run by the continuous delivery network uses the run identifier as the key to retrieve the first test data and/or the second test data from the key-value store for use by the second subsequent test phase.

20. The computer system of claim 17, wherein executing the first run of the testing pipeline by the continuous delivery platform comprises:
storing testing information for each of the plurality of test phases of the first run; and
generating a user interface presenting each test phase of the testing pipeline with the testing information for each test phase of the first run.
